(19) United States
(12) Patent Application Publication
(10) Pub. No.: US 2006/0070682 A1
(43) Pub. Date: Apr. 6, 2006

(54) MOBILE TRANSFILLING SYSTEM

(76) Inventors: John Melvin, Gulfport, MS (US); Kenneth Carver II., Wiggins, MS (US)

Correspondence Address: NEIL J. COIG, 2355 DRUSILLA LANE, BATON ROUGE, LA, 70809, US

(21) Appl. No.: 10/711,787

(22) Filed: Oct. 5, 2004

(51) Int. Cl. B67C 3/00

(52) U.S. Cl. 141/7

(57) ABSTRACT

A mobile system for transfilling gas canisters, including revised components designed for mobility and a method for implementing the same is disclosed.

### BACKGROUND OF THE INVENTION

The present invention relates to a transfilling system of gas canisters, or tanks, particularly the mobile transfilling of these canisters.

In the traditional use of pressurized gas, a customer uses a pressurized canister of gas until he is left with an empty canister. Filling the canister with pressurized gas is not only dangerous, but maintaining a facility and the associated equipment needed to run the same is expensive as well, and usually left to dedicated operators who run transfilling facilities, rather than the end-users of gas canisters.

To expedite the process of transfilling, the traditional transfiller will either pick up, or accept for delivery, empty canisters from its customer, typically exchanging them for other canisters if the customer needs them, or simply keeping the canisters long enough to properly vent and re-fill them. In many areas, the turnaround time for such refilling, or transfilling, is approximately one week, but can obviously be much longer if the work load is high, the transfillers geographic area is large, or other myriad reasons which lead to extended transfilling times.

Obvious downsides to this method exist, not the least of which is the absence of the customers' canisters while they are being refilled during the turnaround of the canisters. In the alternative, a customer can purchase or rent additional canisters as “standby” canisters, which brings with it other negative aspects, such as increased complications and time commitment. For these reasons, and secondly disadvantageous, the customer must keep on hand enough extra canisters to compensate for when refilling is necessary, thus increasing cost, or operate without those canisters at times when they are being refilled.

Thirdly, canisters are often lost while in processing with the transfiller, or the transfiller is late returning the canisters. While a transfiller losing tanks should not cost the customer money, the transfiller loses money as a result of replacing missing canisters, and the customer may face the inconvenience of further delays in being returned canisters to use in its operation. Similarly, damage can occur to canisters during the time-consuming process of transfilling, which is no surprise given the extensive time and travel the canisters undergo as part of the traditional transfilling process, leading to many of the same complications as with canister loss.

Furthermore, there is another disadvantage in the typical swapping arrangement: there is no guarantee that the same canisters deposited will be those returned. This means that a customer may spend a considerable amount of money to purchase quality canisters only to have his new, expensive canisters replaced with used ones. Given that these are aluminum tanks, their life is limited, and being returned old tanks can reduce the utility and/or longevity of a customer's canisters, or worse still, pose a safety risk to a customer that is otherwise a careful handler of canisters, since the customer can no longer vouch for the integrity of the canister nor the maintenance delivered to it. Thus, canister exchanging is a real detriment, and a real concern for the customer of gas transfillers.

The present invention of on-site transfilling is thus a much-improved method of transfilling containers from several standpoints, primarily because it overcomes the multitude of problems recited above. Turnaround time is also advantageous in the proposed invention from a responsiveness standpoint. That is, the transfilling station can be located to a customer's location quickly and a mobile transfilling operator can transfill canisters on the spot, in cases of catastrophic loss of canisters, storms, heavy usage or other unexpected need for gas on short notice.

All of these aspects of the current mode of transfilling lead to an increased need for a revised method of replenishing pressurized gas supplies to customers with a minimized cost, time, money and undesirable canister swapping.

### OBJECTS OF THE INVENTION

One object of the invention is to provide a mobile transfilling station for filling gas canisters.

Another object of this invention is to provide a more cost-efficient method of transfilling gas canisters.

Yet another object of this invention is to extend the life of a customer's canisters used in transfilling gases.

Still another object of this invention is to provide a transfilling system with a smaller footprint for ease in transport.

Still another object of this invention is to provide a transfilling system which enables a canister user to utilize fewer tanks in its operation.

Still another object of this invention is to provide a transfilling system which is able to respond more quickly to consumer demand.

Other objects and advantages of this invention shall become apparent from the ensuing descriptions of the invention.

### SUMMARY OF THE INVENTION

According to the present invention, a mobile transfilling system is provided. A mobile system for transfilling gas canisters on-site, including revised components designed for mobility and a method for implementing the same is disclosed.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a flow chart of the exemplary embodiment of the mobile transfilling system.

FIG. 2 is a flow chart of the prior art system of transfilling canisters.

FIG. 3 is a rear view of the interior of the mobile transfilling system.

FIG. 4 is a side view of the mobile transfilling system.

### DETAILED DESCRIPTION OF EXEMPLARY EMBODIMENTS

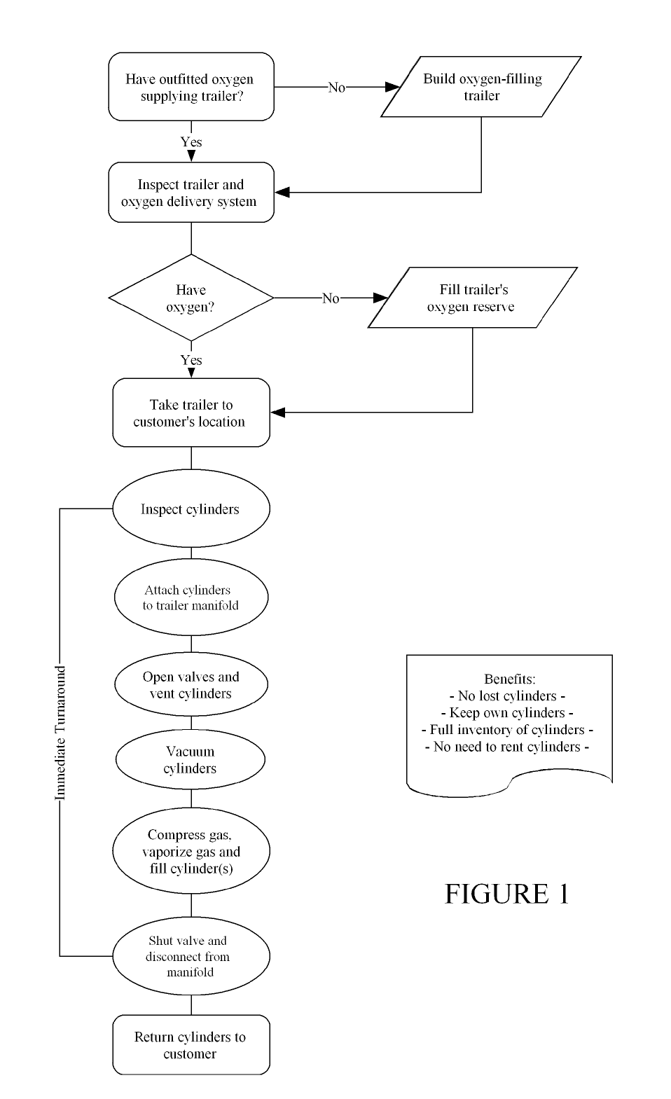

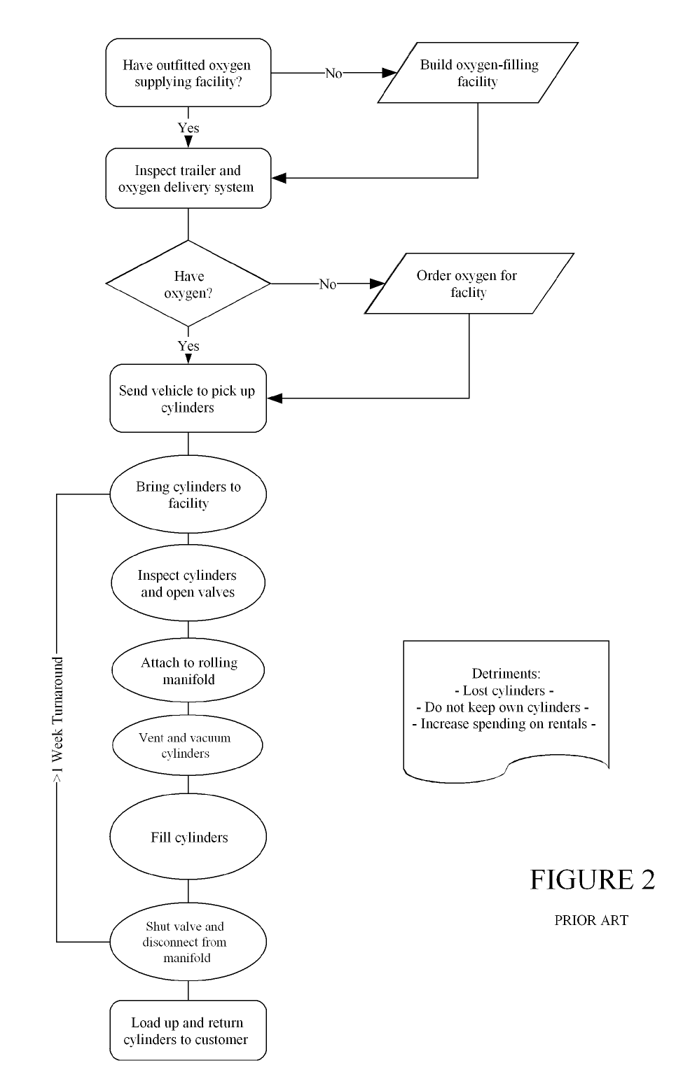

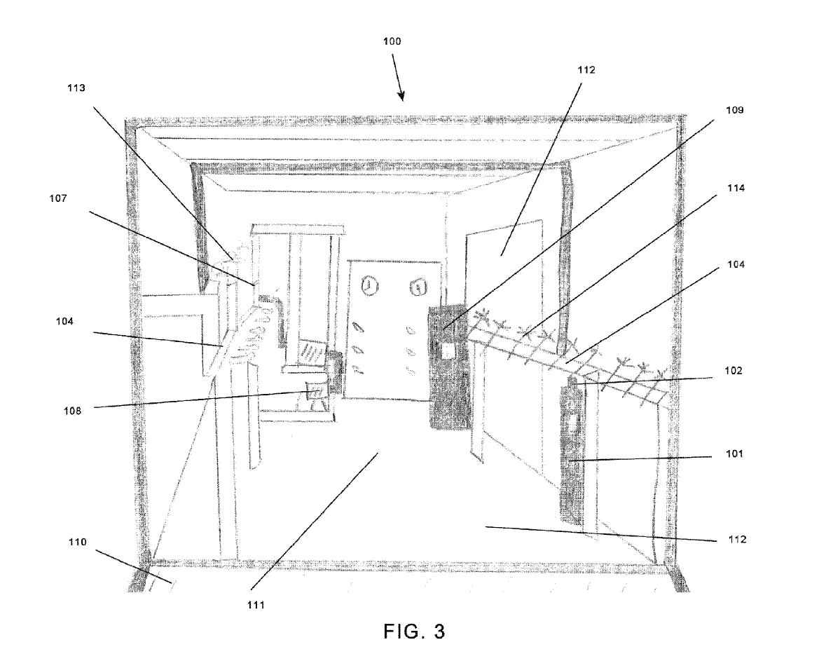

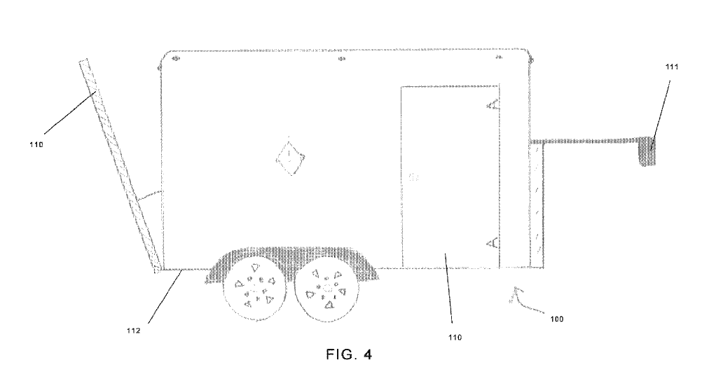

Without any intent to limit the scope of this invention, reference is made to the figures in describing the various embodiments of the invention. FIGS. 1-4 show various aspects of exemplary embodiments of the present invention.

Transfilling station 100 requires certain accommodations over the prior art method of transfilling in order to be contained in the footprint of the mobile trailer or vehicle. Most of these concessions are necessitated by a relative lack of space, but also by other considerations, such as mobility, weight, efficiency and the like. The basic design of transfilling station 100 is that of an enclosed trailer, having typically four walls, a floor and a ceiling creating an enclosed space 111.

Such considerations include a change in the design of the typical moving, assembly line-type system. In current implementation, the canisters 101 are placed on a moving apparatus, and much in the fashion of an assembly line process, canisters 101 are transfilled. Instead of this technique, the mobile transfiller utilizes a stationary transfilling mechanism, with manifolds 104 that are fixed to the floor of transfilling station 100.

Taller vaporizers 107 are employed which permit a vaporizer 107 of similar volumetric capacity to be used in a smaller floor area location than the wider vaporizer 107 used in current methods. The components are also positioned much closer together in order to conserve space than they would otherwise be.

Specifically-designed and positioned trailer doors 112 are employed on the transfilling station 100 to accommodate the loading and unloading of canisters 101, and storage tanks 109, as well as the periodic maintenance that may be required on the transfilling machinery. There would also ideally be ramp 110 to facilitate entry and exit into transfilling station 100 with tanks and equipment.

When in trailer form, the transfilling station is also configured with a heavy-duty hitching mechanism (also known as a “fifth wheel” hitch 111), required because of the weight of the transfilling station. Reinforced floors 112 can also be implemented to support the increased weight of the transfilling apparatus and canisters 101.

An exemplary embodiment of the invention is the method picture in FIG. 1. In operation, the first step in this method is to obtain or construct a mobile transfilling station 100. Such a station can be a trailer or other vehicle. The exemplary embodiment presented herein will be the version of the transfilling station constructed on a trailer, and will use oxygen as the exemplary gas to be transfilled. Obviously, varying vehicles and gases can be employed in this method, such as self-propelled trucks, rail cars and the like, as well as other gases be transfilled, such as medical oxygen, CO₂ and other gases.

Once constructed, the transfilling station 100 will be filled with liquid oxygen from a repository, which can be from any location, such as the operator's own reserves, or from a central oxygen supplier. A common storage method is in low-pressure insulted vacuum containers, known as dewars, that are stored onboard transfilling station 100. The transfilling station 100 is then transported to a customer's location, where canisters 101 are sought to be filled.

A customer's canisters 101 are inspected in order to determine their suitability for refilling. As canisters 101 have a finite life, and given the high pressure of the gases within, they must be assured of their fitness to continue in service, which is the function this inspection serves. Once inspected, canisters 101 are attached to the station's 100 manifold 104, and the canisters' valves 102 are opened. This permits remaining pressure and contents to be evacuated to the atmosphere, and then canisters 101 are vacuumed to ensure the removal of any remaining gas and/or contaminants using a vacuum pump.

Then, the liquefied oxygen stored in the transfilling station 100 at a relatively low-pressure (approximately 150 pounds per square inch) is directed from the transfilling station's 100 reservoir and compressed by being fed through compressor 108, and then through heat exchangers 107, also known as vaporizers, where the gas is pressurized to approximately 2000 psi and fed to manifold 104. From here, the pressurized gas is distributed to all of canisters 101 attached to manifold 104.

Once the appropriate amount of gas is dispensed into canisters 101, the transfer process is terminated, and valves 102 are shut on canisters 101. Canisters 101 are then disconnected from manifold 104 and returned to customer.

There are various types of canisters for different gases, and in the exemplary embodiment pictured in the FIGs, there are two primary types of tank connections, tank “H” specifications tank “E” specifications. The significance of these is size; namely, the “E” tank is a smaller tank than the “H, ” and as such, requires a different size connection. These configurations could, of course, be adapted to any type or size of tank. In the embodiment pictured, there are several tank “H” connections 113 and many more tank “E” connections 114.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for transfilling gas canisters on-site comprising:
transporting a transfilling station to a desired transfilling site;
attaching gas canisters to said transfilling station;
inspecting and evacuating said gas canisters;
vaporizing and compressing a gas and directing it into said gas canisters;
disconnecting said gas canisters; and
transporting said transfilling station from said transfilling site.

2. The method of transfilling gas canisters on-site of claim 1 wherein said gas is medical oxygen.

3. An mobile gas canister transfilling station comprising:
a mobile chassis;
a substantially enclosed space mounted on said mobile chassis;
at least one door grating access to said enclosed space from outside of said enclosed space;
at least one ramp for facilitating the transport of gas canisters in and out of said enclosed space;
at least one manifold shaped to receive transfilling canisters attached to said transfilling station;
at least one heat exchanger operatively connected to said manifolds;
at least one compressor operatively connected to said heat exchanger.

4. The mobile gas canister transfilling station of claim 3 further comprising a hitching mechanism for attaching to a towing vehicle.

5. The mobile gas canister transfilling station of claim 3 wherein said floor is reinforced to support increased weight.

6. The mobile gas canister transfilling station of claim 3 further comprising at least 48 manifolds that conform to tank “E” specifications and at least 4 manifolds that conform to tank “H” specifications.
